(19) United States
(12) Patent Application Publication
(10) Pub. No.: US 2017/0017928 A1
(43) Pub. Date: Jan. 19, 2017

(54) INFERRING PHYSICAL MEETING LOCATION

(71) Applicant: MICROSOFT TECHNOLOGY LICENSING, LLC, Redmond, WA (US)

(72) Inventors: ADI MILLER, TEL AVIV (IL); SHIRA WEINBERG, TEL AVIV (IL); ADI GERZI, TEL AVIV (IL)

(21) Appl. No.: 14/800,394

(22) Filed: Jul. 15, 2015

(51) Int. Cl. G06Q 10/10

(52) U.S. Cl. CPC G06Q 10/1095

(57) ABSTRACT

A most probable physical meeting location is provided to a user or third-party in response to receiving a subjective reference to the physical meeting location. A collection of physical meeting location values, or objective references to one or more physical meeting locations, are collected based at least in part on sensor data associated with the user. For each subjective reference to a physical meeting location, one or more location clusters comprising objective references to one or more physical meeting locations is generated. As a response to receiving the subjective reference to the physical meeting location, a probable meeting location generated based on cluster density associated with each of the one or more location clusters is provided to the user or third-party.

### BACKGROUND

People regularly rely on electronic calendar applications to organize their meetings, dates, tasks, and the like. Such electronic calendar applications can organize and keep calendar information that is associated with a user account, accessible only to a user having credentials to access the user account. Electronic calendar information can be stored remotely, for instance, on a cloud-based server. In this regard, a user can access the calendar information from one or more devices having access to the cloud-based server by way of an electronic calendar application. The calendar information can include calendar meeting details specifying, among other things, meeting timeframes, meeting invitees, meeting subjects, and meeting locations. Oftentimes, meeting location details associated with calendar meetings can be deficient in detail (i.e., provided in shorthand without specifying physical location information, such as an address). Users typically provide subjective, shorthand references (e.g., “Adi's Office”) as the meeting location because it is less time consuming to provide the shorthand reference than to provide the entire address. For the same reasons, users may leave the meeting location blank, or include the location or shorthand references thereto in the meeting subject.

As smart phones and computers are growing more capable of providing personalized user experiences, some computer applications are capable of cross-pollenating application data to facilitate such experiences. For instance, a GPS navigation application may be configured to automatically populate a destination field with an upcoming meeting location communicated from an electronic calendar application. An application, such as the foregoing, can work as intended when provided with objective physical location information associated with the upcoming meeting. However, in scenarios where meeting details are subjective, particularly with regards to the physical meeting location, such applications fail to determine a precise destination. In this regard, there is a significant disconnect between subjective references to meeting locations and the actual, objective physical meeting location information.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Embodiments described in the present disclosure are directed towards inferring objective physical meeting locations for calendar meetings having subjective meeting location descriptions associated therewith. In particular, embodiments may determine a probable physical meeting location for a calendar meeting based on a history of sensed physical meeting location information that corresponds to other instances of the calendar meeting or other calendar meetings sharing common characteristics therewith. By analyzing a history of calendar meetings associated with a user along with sensor data collected by the user's device(s) at the time of the calendared meetings, an objective physical meeting location can be inferred for at least some calendar meetings having deficient meeting location information. In some embodiments, calendar meetings that are created or accepted by the user may have more significance to a user than one that is deleted or rejected by the user, particularly when making inferences on objective physical meeting locations.

For example, computing devices associated with a user can employ sensors to generate data relevant to a user's actual physical location at the time of the user's one or more calendared meetings. A meeting location register can be employed to record the actual physical location of the user at the time of the one or more meetings. To this end, if the meeting location information for a calendar meeting is deficient or merely includes a subjective description, the location register can provide a collected sample of data points that can be analyzed to infer a most probable objective physical location of the calendared meeting.

In some embodiments, a meeting location analyzer can be provided to analyze the data points recorded in the meeting location register. When provided with an upcoming calendar meeting having a deficient meeting location description, the meeting location analyzer can identify records having some correlation to the deficient meeting location and further determine a probable objective physical location for the calendar meeting. In some aspects, a clustering algorithm may be employed to analyze the data points and further produce confidence scores associated with inferred objective physical locations. For instance, if the meeting location analyzer identifies several probable objective physical locations having a correlation to a deficient meeting location description, the clustering algorithm can determine a most-probable objective physical location based on a calculated confidence score associated therewith, as will be described.

In some other embodiments, the meeting location analyzer can cross-analyze meeting location register data points associated with a plurality of users. For example, when the meeting location analyzer is analyzing data points corresponding to a deficient meeting location description to infer a probable objective physical location for a user's calendar meeting, the meeting location analyzer may also consider data points recorded for other users in their meeting location registers to improve its predictive analysis. In this regard, the meeting location analyzer may consider data points for analysis from a plurality of users.

Accordingly, aspects of the present disclosure relate to inferring objective physical meeting location for calendar meetings having deficient meeting locations associated therewith. The terms “objective location” or “physical location” are used broadly herein to include any description for a location that can be interpreted by a user or computer application to determine a particular geographic locus. By way of example and not limitation, an objective physical meeting location can include GPS coordinates, latitude and longitude coordinates, an address, Earth Centered Earth Fixed (ECEF) Cartesian coordinates, Universal Transverse Mercator (UTM) coordinates, Military Grid Reference Systems (MGRS) coordinates, and the like. By associating calendar meetings having deficient meeting location descriptions with these objective physical meeting locations, detailed physical location information for a calendar meeting can be provided so as to auto-propagate, tailor, or personalize content for the user.

### BRIEF DESCRIPTION OF THE DRAWINGS

Aspects of the present disclosure are described in detail below with reference to the attached drawing figures, wherein:

FIG. 1 is a block diagram of an example operating environment suitable for implementing aspects of the present disclosure;

FIG. 2 is a diagram depicting an example computing architecture suitable for implementing aspects of the present disclosure;

FIG. 3 depicts one example of a cluster diagram used in a meeting location analysis, in accordance with an embodiment of the present disclosure;

FIGS. 4-5 depict flow diagrams of methods for determining a probable meeting location value for a subjective meeting location label, in accordance with an embodiment of the present disclosure; and

FIG. 6 is a block diagram of an exemplary computing environment suitable for use in implementing an embodiment of the present disclosure.

### DETAILED DESCRIPTION

The subject matter of aspects of the present disclosure is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Modern electronic calendar applications can store electronic calendar information on a cloud-based server. Electronic calendar information can be access-restricted based on access credentials associated with a user account. As was described, electronic calendar information associated with a particular user can include one or more calendared meetings, each calendared meeting comprising details specifying, among other things, meeting timeframe, meeting invitee(s), meeting subject, and meeting location. Calendar meeting creators and/or editors include most, if not all, of the aforementioned details to provide specific meeting information that can be referenced by the creator and/or the invitees as needed.

As more cloud-based applications are sharing or “cross-pollinating” personal user information to facilitate personalized experiences, the quality of the personalized experience is growing dependent on the quality of information that is being collected, shared, and analyzed. For instance, cloud-based personalization-related (e.g., “personal assistant”) applications can be configured to collect data from a plurality of cloud-based applications associated to a particular user. By collecting data from multiple applications associated to the particular user, and further analyzing the data to find correlations there between, personalization-related applications can make inferences based on the analysis to personalize the user experience (e.g., automate actions, automatically populate fields, make personalized recommendations, etc.). The deficiency of detailed information, however, can negatively impact personalization and automation. More specifically, if calendared meeting information is shared and analyzed for personalization and/or automation purposes, but meeting information is vague or non-descriptive, applications receiving the deficient information will not be able to properly interpret the information. For example, if a GPS navigation application was configured to automatically populate the destination field in view of an upcoming calendared meeting, a deficient meeting location description (e.g., “Adi's Office) would likely produce an error or irrelevant result. In another example, if a new invitee is added to a calendar meeting having a deficient meeting location description, the new invitee may have no idea how to interpret the deficient meeting location.

As such, aspects of the technology described herein are directed towards inferring physical meeting locations for calendar meetings having deficient meeting locations associated therewith. Embodiments may determine a most probable objective description of a physical location for a particular calendar meeting when the meeting location associated therewith is deficient, subjective, or lacking in detail. Embodiments can receive sensor data associated with a user and, from this, collect physical location information sensed during calendared meeting times to generate a record that can be analyzed to infer probable physical meeting locations for calendared meetings having similar deficiencies. As used herein, the term “deficient” is used to describe data that is non-descriptive, purely subjective, or lacking detail in a way that cannot be interpreted by an objective user or computer application. For example, a deficient meeting location description associated with a calendar meeting can reference a meeting location description known, subjectively, to at least one invitee (e.g., “Adi's Office”, “Building 52”, “My favorite coffee shop”), but can be unknown to other invitees lacking subjective understanding of the description, or unknown to computer applications configured to act on purely objective descriptions (i.e., coordinates, address, etc.) of the physical meeting location.

In some embodiments, one or more electronic calendar information sources associated with a user can be accessed to receive electronic calendar meeting information. For instance, a user can have a user account with one or more electronic calendar services that are configured to store electronic calendar information for the user. In some aspects, the calendar information can be associated with an email address also associated with the user account with the one or more electronic calendar services. The electronic calendar meeting information can include one or more calendar meetings associated with at least the user. Calendar meetings can generally be associated with a user when the user creates the calendar meeting, or is an invitee to the calendar meeting. A calendar meeting can also include, among other things, a meeting timeframe, meeting invitee(s), a meeting subject, and a meeting location. The meeting timeframe typically references a meeting date, a meeting start time, and a meeting end time. Meeting invitees can include references to other meeting invitees that are invited to the meeting. References to the invitees can include names, aliases, email addresses, phone numbers, or other means of contacting the invitees so that the meeting invitation can be communicated to them, among other things. The meeting subject generally includes a textual description of the purpose of the meeting or a point of discussion for the meeting.

The meeting location generally includes a meeting location label. The meeting location label expressly describes the meeting location in plain text. The meeting location label can include any textual description of the meeting location. The meeting location label descriptions can include subjective descriptions, objective descriptions, or a combination of both.

For example, the meeting location label can describe a meeting scheduled to be held at the office of team member, Adi. One or more team members may be familiar with Adi's office, as it may be a common meeting location. Thus, the meeting location label may include a subjective description (i.e., “Adi's Office”). Such a meeting location label is considered subjective because although one or more of the meeting invitees may be well aware of the location of Adi's office, an unfamiliar invitee may not have the subjective knowledge of where Adi's office is located. Similarly, a computer application (i.e., a GPS navigation application) configured to interpret objective descriptions of meeting locations may misinterpret the description or return an error in response to the subjective description. As such, the subjective description can be considered a deficient meeting location description.

In another example, if Adi's Office was in Room 1 of Building 50, the meeting location label could include descriptions such as “Room 1”, “Building 50”, or “Room 1 in Building 50.” In the foregoing examples, the descriptions of the meeting locations are more objective than “Adi's office”, but are still subjective in the sense that these descriptions do not provide a purely objective description of the physical location of the meeting location (i.e., no address or coordinates provided). These meeting location labels may be well known to one or more invitees of the meeting. It is reasonable to assume, however, that these semi-subjective descriptions can still be too vague for an unfamiliar invitee or a computer application to understand objectively. Similar to a purely subjective description, descriptions such as “Room 1”, “Building 50”, or “Room 1 in Building 50” can only be understood by a user who has subjective knowledge of the physical location of these descriptions. Similarly, a computer application (i.e., a GPS navigation application) could receive the such descriptions and have no contextual knowledge or means to interpret the physical location referenced thereby. As such, the semi-subjective description can also be considered a deficient meeting location description.

In some instances, the meeting location label can include a purely objective description of the location. The meeting location label may include the address description, for example, “1 Microsoft Way, Room 1, Redmond, Wash. 98052.” Similarly, the meeting location label may include a coordinate description, such as “47.639, −122.128.” In the immediately foregoing examples, the meeting location labels include purely objective descriptions of the physical meeting location, which can be interpreted by invitees having no prior or subjective knowledge of the meeting location description, and also interpreted by computer applications configured to understand such an objective description. As such, the objective description can be considered an objective, sufficient, or non-deficient meeting location.

The purely objective description of a meeting location will be referenced to herein as the meeting location value. In some cases, the meeting location label can be the same as or substantially similar to the meeting location value. Such cases will be common when the meeting location label objectively describes the meeting location (i.e., when a user includes the physical address or coordinates value as the meeting location label). However, in cases where the meeting location label includes a subjective description of the meeting location, the meeting location value associated therewith may include the objective description of the meeting location, as will be described herein.

In embodiments described herein, a meeting location value is associated with a meeting location label, the meeting location value objectively describing the meeting location label. In some instances, the meeting location label and meeting location value may be the same (i.e., both objective descriptions). In other instances, the meeting location label may be subjective or semi-subjective, while the meeting location value may be purely objective. As will be described, not all meeting location labels will have an associated meeting location value. Nonetheless, one of the goals described in the present disclosure is to determine an objective meeting location value to associate with a subjective meeting location label.

In certain respects, aspects of the present disclosure relate to determining a most probable meeting location value for a meeting location label. In other words, for meeting location labels including subjective descriptions of the meeting location, aspects of the present disclosure aim to infer a most probable meeting location value that objectively describes the meeting location referenced by the subjective meeting location label. To this end, invitees without subjective knowledge of a meeting location label, or computer applications being limited only to objective interpretations of meeting location labels, can now receive an inferred objective physical meeting location based on an analysis of collected user data, as will be described.

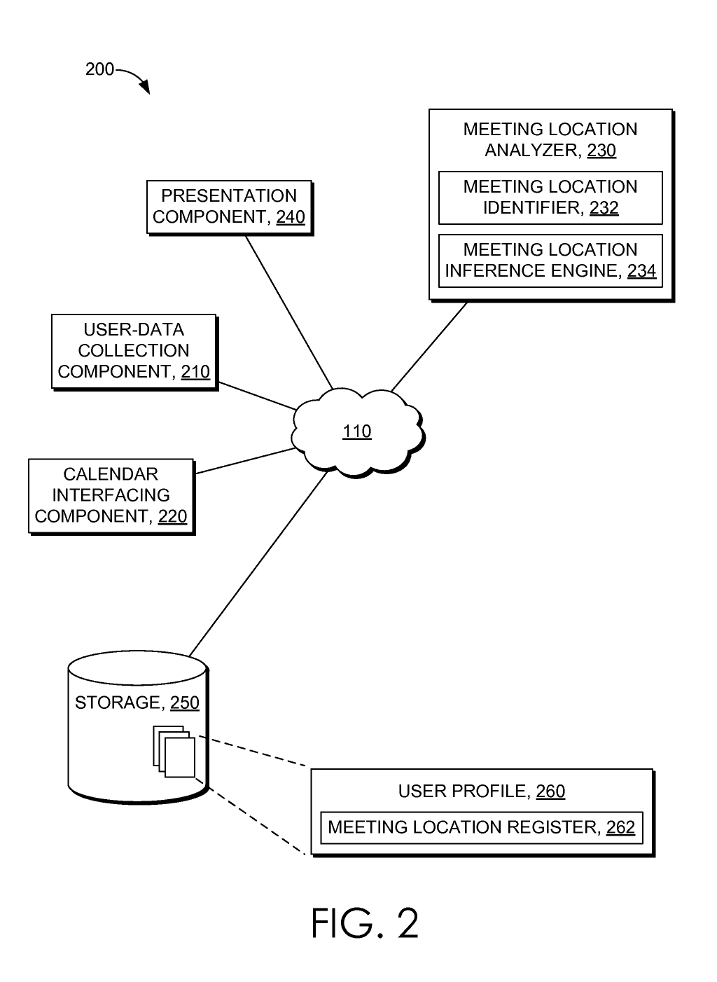

Accordingly, at a high level, in one embodiment, user data is received from one or more data sources. The user data may be received by collecting user data with one or more sensors or components on user device(s) associated with a user. Examples of user data, also described in connection to component 210 of FIG. 2, may include location information of the user's mobile device(s), user-activity information (e.g., app usage, online activity, searches, calls), application data, contacts data, calendar and social network data, or nearly any other source of user data that may be sensed or determined by a user device or other computing device. The received user data may be monitored and information about the user may be stored in a user profile, such as user profile 260 of FIG. 2. The received user data may also include temporal data associated therewith.

In one embodiment, a user profile 260 is utilized for storing user data about the user. In one embodiment, user data collected at least during regularly calendared meeting times (e.g., every Monday from 1:00 PM to 2:00 PM) having associated meeting location labels (e.g., “Adi's Office”) is monitored and used for determining correlations between meeting location values and meeting location labels associated with the user, in order to account for actual, objective descriptions to physical locations corresponding to subjective meeting location labels provided by or associated with the user. Likewise, in one embodiment, where user data indicates that a user, during a regularly calendared meeting time (e.g., every Monday from 1:00 PM to 2:00 PM) associated with a meeting location label (e.g., “Adi's Office”) no longer has interaction with the particular meeting location value (e.g., “1 Microsoft Way, Room 1, Redmond, Wash. 98052”) for a predetermined time frame, such as 1 year, it may be determined that the meeting location value should no longer be associated with the meeting location label. In this scenario, it could potentially be assumed that the meeting location value has changed (i.e., Adi's office location has moved).

A set of meeting location values generally associated with the user may be determined from the received user data. In particular, the user data may be used to determine meeting location values that are relevant to the user, which may be determined based on geographic locations frequented by the user at various meeting times, patterns of user interaction with physical meeting locations at various meeting times, or other user-activity patterns associated with physical meeting locations during various meeting times, for example. Such patterns may include, by way of example and not limitation, a user visiting a particular office every morning for a scheduled calendar meeting having a meeting location label of “Adi's Office”; a particular coffee shop for one hour every Saturday for a scheduled calendar meeting having a meeting location label of “The coffee shop on 3^{rd} Street”; a particular factory once per week for a scheduled calendar meeting having a meeting location label of “John's factory”; a gym for 45 minutes every Monday, Wednesday, and Saturday for a scheduled calendar meeting having a meeting location label of “Gym”; an online meeting from home at 2:00 pm on the first Friday of every month for scheduled meeting location label “Microsoft HQ”; or similar patterns of user interactions with physical meeting locations during regularly calendared meeting times.

In some embodiments, meeting location logic or semantic information about geographic locations visited by the user during calendared meeting times may be used to determine likely meeting location values at physical locations where more than one meeting location values is present, such as a coffee shop that is adjacent to an office building. For example, where user data indicates that the user, during the time of the calendared meeting, detects a Wi-Fi hotspot signal that can be tracked back to a large chain of coffee shops, it may be determined that the meeting location value of interest to the user is more likely the coffee shop. Additionally, in some cases, a user may explicitly indicate that a particular meeting location value is important, and in some embodiments, where user data indicates that a meeting location value may be relevant to a user, the user may be asked to confirm whether the detected meeting location value is correct.

As was previously described, user data may also include user calendar data. One or more electronic calendar information sources associated with a user can be accessed to receive the user's electronic calendar meeting information. The user can have a user account with one or more electronic calendar services that are configured to store electronic calendar information for the user. In some aspects, the calendar information can be associated with an email address also associated with the user account with the one or more electronic calendar services. The calendar meeting information can be accessed once, in intervals, or on-demand from the calendar information sources, for instance, by calendar interfacing component 220 of FIG. 2, collected by user-data collection component 210 of FIG. 2, along with other user data as was described, and/or stored in storage 250 of FIG. 2. The electronic calendar meeting information can include one or more calendar meetings associated with at least the user. Calendar meetings can generally be associated with a user when the user creates the calendar meeting, or is an invitee to the calendar meeting. A calendar meeting can also include, among other things, a meeting timeframe, meeting invitee(s), a meeting subject, and a meeting location, with the meeting location comprising the meeting location label and/or meeting location value. The meeting timeframe typically references a meeting date, a meeting start time, and a meeting end time which can be reconciled with other user data corresponding to a sensed meeting location value.

Some embodiments further include using user data from other users also invited to the same meeting or having similar email address domains (i.e., crowdsourcing data) for determining meeting location values, relevance, confidence, and/or relevant supplemental content for making inferences in probable meeting location values to correspond with a subjective meeting location label. Additionally, some embodiments described herein may be carried out by a personalization-related application or service, which may be implemented as one or more computer applications, services, or routines, such as an app running on a mobile device or the cloud, as further described herein.

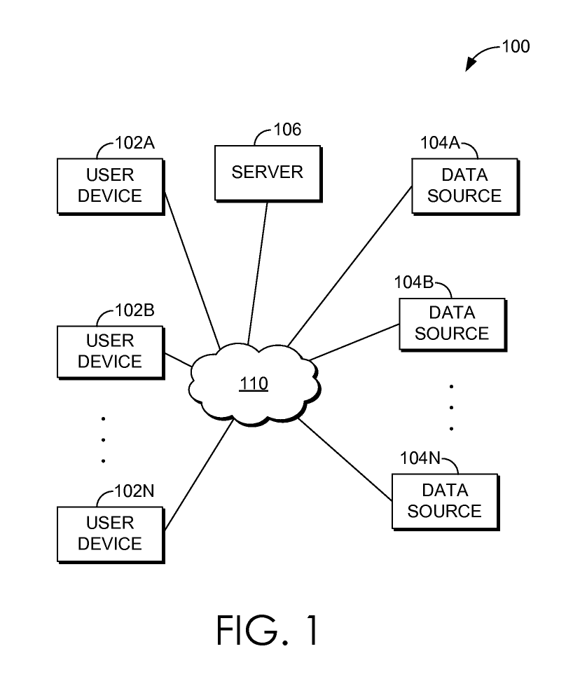

Turning now to FIG. 1, a block diagram is provided showing an example operating environment 100 in which some embodiments of the present disclosure may be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, some functions may be carried out by a processor executing instructions stored in memory.

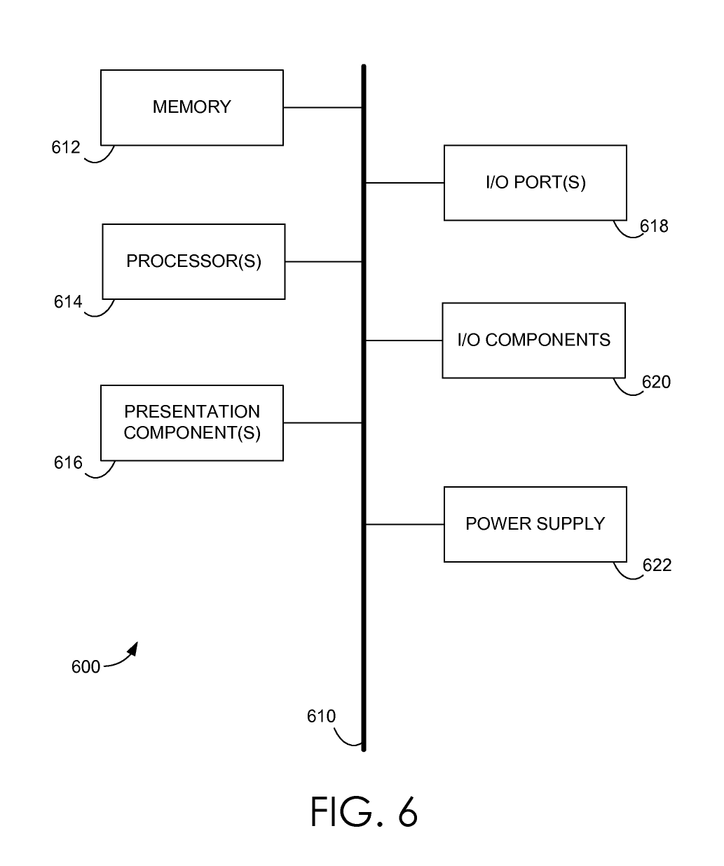

Among other components not shown, example operating environment 100 includes a number of user devices, such as user devices 102a and 102b through 102n; a number of data sources, such as data sources 104a and 104b through 104n; server 106; and network 110. It should be understood that environment 100 shown in FIG. 1 is an example of one suitable operating environment. Each of the components shown in FIG. 1 may be implemented via any type of computing device, such as computing device 600 described in connection to FIG. 6, for example. These components may communicate with each other via network 110, which may include, without limitation, one or more local area networks (LANs) and/or wide area networks (WANs). In exemplary implementations, network 110 comprises the Internet and/or a cellular network, amongst any of a variety of possible public and/or private networks.

It should be understood that any number of user devices, servers, and data sources may be employed within operating environment 100 within the scope of the present disclosure. Each may comprise a single device or multiple devices cooperating in a distributed environment. For instance, server 106 may be provided via multiple devices arranged in a distributed environment that collectively provide the functionality described herein. Additionally, other components not shown may also be included within the distributed environment.

User devices 102a and 102b through 102n can be client devices on the client-side of operating environment 100, while server 106 can be on the server-side of operating environment 100. Server 106 can comprise server-side software designed to work in conjunction with client-side software on user devices 102a and 102b through 102n so as to implement any combination of the features and functionalities discussed in the present disclosure. This division of operating environment 100 is provided to illustrate one example of a suitable environment, and there is no requirement for each implementation that any combination of server 106 and user devices 102a and 102b through 102n remain as separate entities.

User devices 102a and 102b through 102n may comprise any type of computing device capable of use by a user. For example, in one embodiment, user devices 102a through 102n may be the type of computing device described in relation to FIG. 6 herein. By way of example and not limitation, a user device may be embodied as a personal computer (PC), a laptop computer, a mobile or mobile device, a smartphone, a tablet computer, a smart watch, a wearable computer, a personal digital assistant (PDA), an MP3 player, a global positioning system (GPS) or device, a video player, a handheld communications device, a gaming device or system, an entertainment system, a vehicle computer system, an embedded system controller, a remote control, an appliance, a consumer electronic device, a workstation, or any combination of these delineated devices, or any other suitable device.

Data sources 104a and 104b through 104n may comprise data sources and/or data systems, which are configured to make data available to any of the various constituents of operating environment 100, or system 200 described in connection to FIG. 2. (For example, in one embodiment, one or more data sources 104a through 104n provide (or make available for accessing) user data to user-data collection component 210 of FIG. 2.) Data sources 104a and 104b through 104n may be discrete from user devices 102a and 102b through 102n and server 106 or may be incorporated and/or integrated into at least one of those components. In one embodiment, one or more of data sources 104a though 104n comprise one or more sensors, which may be integrated into or associated with one or more of the user device(s) 102a, 102b, or 102n or server 106. Examples of sensed user data made available by data sources 104a though 104n are described further in connection to user-data collection component 210 of FIG. 2

Operating environment 100 can be utilized to implement one or more of the components of system 200, described in FIG. 2, including components for collecting user data, monitoring events, generating inferences, and/or presenting probable meeting location values and related content to users. Referring now to FIG. 2, with FIG. 1, a block diagram is provided showing aspects of an example computing system architecture suitable for implementing an embodiment of the present disclosure and designated generally as system 200. System 200 represents only one example of a suitable computing system architecture. Other arrangements and elements can be used in addition to or instead of those shown, and some elements may be omitted altogether for the sake of clarity. Further, as with operating environment 100, many of the elements described herein are functional entities that may be implemented as discrete or distributed components or in conjunction with other components, and in any suitable combination and location.

Example system 200 includes network 110, which is described in connection to FIG. 1, and which communicatively couples components of system 200 including user-data collection component 210, calendar interfacing component 220, meeting location analyzer 230, presentation component 240, and storage 250. Meeting location analyzer 230 (including its components meeting location identifier 232 and meeting location inference engine 234), user-data collection component 210, calendar interfacing component 220, and presentation component 240 may be embodied as a set of compiled computer instructions or functions, program modules, computer software services, or an arrangement of processes carried out on one or more computer systems, such as computing device 600 described in connection to FIG. 6, for example.

In one embodiment, the functions performed by components of system 200 are associated with one or more personalization-related (e.g., “personal assistant”) applications, services, or routines. In particular, such applications, services, or routines may operate on one or more user devices (such as user device 102a), servers (such as server 106), may be distributed across one or more user devices and servers, or be implemented in the cloud. Moreover, in some embodiments, these components of system 200 may be distributed across a network, including one or more servers (such as server 106) and client devices (such as user device 102a), in the cloud, or may reside on a user device, such as user device 102a. Moreover, these components, functions performed by these components, or services carried out by these components may be implemented at appropriate abstraction layer(s) such as the operating system layer, application layer, hardware layer, etc., of the computing system(s). Alternatively, or in addition, the functionality of these components and/or the embodiments described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific components shown in example system 200, it is contemplated that in some embodiments functionality of these components can be shared or distributed across other components.

Continuing with FIG. 2, user-data collection component 210 is generally responsible for accessing or receiving (and in some cases also identifying) user data from one or more data sources, such as data sources 104a and 104b through 104n of FIG. 1. In some embodiments, user-data collection component 210 may be employed to facilitate the accumulation of user data of one or more users (including crowdsourced data) for, among other things, meeting location analyzer 230. The data may be received (or accessed), and optionally accumulated, reformatted, and/or combined, by user-data collection component 210 and stored in one or more data stores such as storage 250, where it may be available to meeting location analyzer 230. For example, the user data may be stored in or associated with a user profile 260, as described herein. In some embodiments, any personally identifying data (i.e., user data that specifically identifies particular users) is either not uploaded from the one or more data sources with user data, is not permanently stored, and/or is not made available to meeting location analyzer 230.

User data may be received from a variety of sources where the data may be available in a variety of formats. For example, in some embodiments, user data received via user-data collection component 210 may be determined via one or more sensors, which may be on or associated with one or more user devices (such as user device 102a), servers (such as server 106), and/or other computing devices. As used herein, a sensor may include a function, routine, component, or combination thereof for sensing, detecting, or otherwise obtaining information such as user data from a data source 104a, and may be embodied as hardware, software, or both. By way of example and not limitation, user data may include data that is sensed or determined from one or more sensors (referred to herein as sensor data), such as location information of mobile device(s), smartphone data (such as phone state, charging data, date/time, or other information derived from a smartphone), user-activity information (for example: app usage; online activity; searches; voice data such as automatic speech recognition; activity logs; communications data including calls, texts, instant messages, and emails; website posts; other user data associated with communication events; etc.) including user activity that occurs over more than one user device, user history, session logs, application data, contacts data, calendar and schedule data, notification data, social network data, news (including popular or trending items on search engines or social networks), online gaming data, ecommerce activity (including data from online accounts such as Microsoft®, Amazon.com®, Google®, eBay®, PayPal®, video-streaming services, gaming services, or Xbox Live®), user-account(s) data (which may include data from user preferences or settings associated with a personalization-related (e.g., “personal assistant”) application or service, home-sensor data, appliance data, global positioning system (GPS) data, vehicle signal data, traffic data, weather data (including forecasts), wearable device data, other user device data (which may include device settings, profiles, network connections such as Wi-Fi network data, or configuration data, data regarding the model number, firmware, or equipment, device pairings, such as where a user has a mobile phone paired with a Bluetooth headset, for example), gyroscope data, accelerometer data, payment or credit card usage data (which may include information from a user's PayPal account), purchase history data (such as information from a user's Amazon.com or eBay account), other sensor data that may be sensed or otherwise detected by a sensor (or other detector) component including data derived from a sensor component associated with the user (including location, motion, orientation, position, user-access, user-activity, network-access, user-device-charging, or other data that is capable of being provided by one or more sensor component), data derived based on other data (for example, location data that can be derived from Wi-Fi, cellular network, or IP address data), and nearly any other source of data that may be sensed or determined as described herein. In some respects, user data may be provided in user-data streams or signals. A “user signal” can be a feed or stream of user data from a corresponding data source. For example, a user signal could be from a smartphone, a home-sensor device, a GPS device (e.g., for location coordinates), a vehicle-sensor device, a wearable device, a user device, a gyroscope sensor, an accelerometer sensor, a calendar service, an email account, a credit card account, or other data sources. In some embodiments, user-data collection component 210 receives or accesses data continuously, periodically, or as needed.

User data, particularly in the form of calendar data, can be received by user-data collection component 210 from one or more electronic calendar information sources. Electronic calendar information may be received from network-accessible calendar accounts such as Microsoft® Outlook®, Google® Calendar, Teamup® Calendar, etc. The one or more electronic calendar information sources can be accessed by calendar interfacing component 220, configured to interface with each electronic calendar information source and request and/or receive the calendar-type user data (e.g., meeting dates, meeting times, meeting invitees, meeting location labels, meeting alerts, events, notifications, etc.) therefrom. In some embodiments, user-data collection component 210 can operate in conjunction with or in lieu of calendar interfacing component 220 to receive the user calendar data.

Meeting location analyzer 230 is generally responsible for monitoring user data for sensed meeting location values, particularly during calendared meeting times, or for information that may be used to identify meeting location values at such times, analyzing user data to identify meeting location values for particular meeting location labels over time, and determining probable meeting location values for a particular meeting location label. As described previously, meeting location values corresponding to a meeting location label may be determined by monitoring user data received from user-data collection component 210. In some embodiments, the user data and/or information about the user determined from the user data is stored in a user profile, such as user profile 260.

At a high level, embodiments of meeting location analyzer 230 may determine, from the user data, a set of meeting location labels, and user-related activity, patterns, or interactions associated with the meeting location labels, or other meeting location-related data, which may be stored in the meeting location register 262 of user profile 260. In some embodiments, meeting location analyzer 230 comprises an inference engine (such as a rule based or machine-learning-based inference engine) that is utilized to identify and monitor meeting location values. The inference engine (not shown) may utilize interpretive data to associate user data with one or more meeting location values, as well as to identify meeting location-relevant information from common invitees or other users having common profile characteristics (e.g., common email domain names).

In one embodiment, user data within certain a time frame (i.e., during a calendared meeting time) is monitored and used for determining a meeting location value that corresponds to a meeting location label of a user's calendared meeting. Likewise, in one embodiment, where user data indicates that a user interacts with a particular meeting location value regularly during a calendared meeting having a particular meeting location label, it may be determined that the meeting location value should be inferred for future calendared meetings referencing the meeting location label. In another embodiment, where user data indicates that a user interacts with various meeting location values during a calendared meeting having a particular meeting location label, it may be determined that one particular meeting location value should be inferred for future calendared meetings referencing the meeting location label. In some embodiments, meeting location analyzer 230 monitors user data associated with the meeting location label and other related information across multiple computing devices or in the cloud.

As shown in example system 200, meeting location analyzer 230 comprises at least a meeting location identifier 232 and a meeting location inference engine 234. In some embodiments, meeting location analyzer 230 and/or one or more of its subcomponents may determine interpretive data from received user data. Interpretive data corresponds to data utilized by the subcomponents of meeting location analyzer 230 to interpret user data. For example, interpretive data can be used to provide context to user data, which can support determinations or inferences made by the subcomponents. Moreover, it is contemplated that embodiments of meeting location analyzer 230 and its subcomponents may use user data and/or user data in combination with interpretive data for carrying out the objectives of the subcomponents described herein.

Meeting location identifier 232, in general, is responsible for determining a meeting location value for a user. In some embodiments, meeting location identifier 232 identifies a meeting location value by monitoring user data for meeting location-related information. As was described, meeting location values can include coordinate information, address information, venue name information, among other meeting location-identifying values. In some embodiments, meeting location values may be inferred using an inference engine and analyzed for relevance to a user based on, for example, the association of user data with the meeting location-related data. By way of example, meeting location values may be inferred by analyzing user data (including interpretive data) for meeting location-related information, such as user location activity indicating patterns of visiting geographic locations corresponding to meeting location values or online activity such as websites or social media pages visited by a user, communications associated with meeting locations (such as emails received from a business or school), purchase history, or combinations of these. In some cases, meeting location values may be identified using a knowledge base (such as a semantic knowledge base) of venues or entities associated with data features observed in user data, such as meeting location values associated with geographic locations, domains of websites or emails, phone numbers, etc. In some embodiments, similar methods may be utilized by search engines to identify entities that may be relevant to a user based on user search queries and/or user search history.

In some embodiments, the meeting location identifier 232 identifies a meeting location value for a particular meeting location label based on user data collected during a timeframe associated with the particular meeting location label. For example, if a meeting was scheduled for Monday, Jul. 6, 2015, from 1:00 PM to 2:00 PM, and the meeting was to be held at “Adi's Office,” the meeting location identifier 232 can analyze the user data to determine meeting location-related information collected on Monday, Jul. 6, 2015, from 1:00 PM to 2:00 PM, to determine a meeting location value for association with “Adi's Office.” The identified meeting location value for the meeting location label (e.g., “Adi's Office”) can then be stored in a log, such as meeting location register 262. More specifically, the meeting location register 262 may keep a log of the meeting location label and the determined meeting location value for the meeting location label at a particular meeting time.

Meeting location inference engine 234, in general, is responsible for analyzing a plurality of meeting location values associated with a particular meeting location label. More specifically, as meeting location identifier 232 determines meeting location values for meeting location labels over a duration of time, and the various meeting location values determined to be associated with various meeting location labels are logged in meeting location register 262, the meeting location inference engine 234 can be configured to analyze meeting location data in the meeting location register 262 to determine probable meeting location values for upcoming calendared meetings having familiar meeting location labels, as will be described in more detail herein.

As meeting location values are identified, the meeting location register 262 logs the data in a table or database comprising meeting location labels and associated meeting location values determined at a particular meeting time. As meeting location values are identified for one or more meeting location labels, the meeting location labels and their associated values become familiar and can be referenced by, for instance, a lookup function. For example, the table may include one hundred unique records of past meetings held at “Adi's Office,” where twenty-five of the meeting location values for “Adi's Office” were determined to be held at coordinates approximate to 47.647, −122.123, and seventy-five of the meetings were determined to be approximate to coordinates 47.639, −122.128. The meeting location inference engine 234 can be queried to analyze, for any particular meeting location label, the meeting location values associated with the meeting location label over time. In embodiments, the meeting location inference engine 234 can search the meeting location register 262 for each meeting location value being associated with the search parameter, or in other words, the meeting location label. In this regard, if the meeting location register 262 was queried, for example only, with parameter “Adi's Office”, it is contemplated that the twenty-five records having coordinates approximate to 47.647, −122.123, and the seventy-five records having coordinates approximate to 47.639, −122.128 will be returned and/or analyzed.

In some embodiments, the meeting location inference engine 234 can be configured to analyze the meeting location values associated with a particular meeting location label by employing a clustering algorithm. Although embodiments herein describe the employment of a clustering algorithm, other methods of data analysis are considered within the scope of the present disclosure. The clustering algorithm can be employed to plot the coordinate values for each of the meeting location values being analyzed. For instance, if a history of meeting location values for “Adi's Office” was being analyzed, the clustering algorithm can plot each of the coordinate values associated with meeting location label “Adi's Office” and determine, based on cluster density, a probable meeting location value to associate with the meeting location label “Adi's Office.” To this end, if a probable meeting location value for an upcoming meeting at “Adi's Office” was requested by a third-party application (e.g., a GPS navigation application), an analysis conducted on a historical record of meeting location values for “Adi's Office” can provide a probable meeting location value, which can then be used for automatically populating input fields (e.g., a destination location) or predicting a physical location for the meeting.

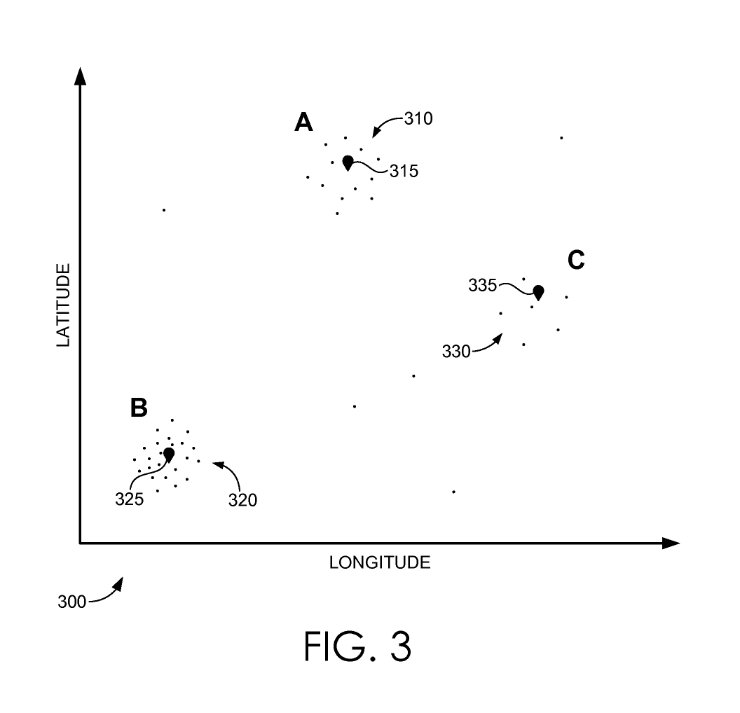

The clustering algorithm can be useful for determining a most probable meeting location value based on one or more meeting location values recorded in the meeting location register 262. Looking now to FIG. 3, an exemplary coordinate map 300 having a plurality of plotted meeting location values is illustrated. As was described, plotting of the coordinate values can be conducted on a coordinate map that corresponds to at least one of the meeting location values. For instance, if the coordinate values are each in standard GPS form, then the coordinate map for plotting will include a standard GPS coordinate system. Similarly, if the meeting location value is a physical address of the meeting location, it is contemplated that a conversion to the common coordinate system is performed on the physical address. To this end, if any one or more coordinate values are from a different coordinate system, the one or more coordinate values can be converted to a common coordinate system that can be plotted on the coordinate map for analysis. While the term “map” is used herein, it is contemplated that the map is merely a virtual map or a data structure employed by the clustering algorithm for facilitating the virtual representation of meeting location values that are analyzed for determining cluster density, as will be described.

Cluster density can be determined for a group of approximate data points (e.g., meeting location values) on a coordinate map. By way of example only, if a plurality of meeting location values (e.g., Cluster A 310) were grouped around Location A 315: (e.g., 47.647, −122.123), and another plurality of meeting location values (e.g., Cluster B 320) were grouped around Location B 325: (e.g., 47.639, −122.128), a cluster density can be determined for each of Clusters A 310 and B 320, based on the number of data points (e.g., meeting location values) that are proximate to one another in each cluster. Clusters will typically populate around specific physical meeting locations, such as a building, structure, venue, shop, park, or other geographic location.

The meeting location inference engine 234 can further analyze the one or more clusters 310, 320 to determine a highest density cluster. In embodiments, the meeting location inference engine 234 identifies a highest density cluster for a particular meeting location label by determining which cluster has the highest density of meeting location values proximate thereto. For example, the density of cluster 320 in FIG. 3, surrounding Location B 325, is higher than the density of cluster 310 surrounding Location A 315 or cluster 330 surrounding Location C 335.

A confidence score may correspond to a cluster determined to have a highest density by the meeting location inference engine 234. The confidence score may be impacted by various factors, such as the variance in the clusters plotted by the meeting location inference engine 234, the age of each detected meeting location value forming the clusters, and the number of meeting location values forming the clusters. In some embodiments, the size or relative number of data points for each cluster in proportion to other clusters can provide a confidence score for the cluster being evaluated for being the highest density cluster. By way of example only, coordinate map 300 of FIG. 3 illustrates Clusters A 310, B 320, and C 330. Assuming that Cluster A 310 has seventy-five data points, Cluster B 320 has twenty data points, and Cluster C 330 has five data points, a confidence score for determining that Cluster A 310 has the highest density can be determined, at least in part, by comparing the density of Cluster A 310 in proportion to Clusters B 320 and/or C 330. In some embodiments, a relative density can be compared to a predetermined threshold (e.g., 0.6) to determine that a particular cluster is the highest density cluster. When a highest density cluster is determined by the meeting location inference engine 234, the meeting location inference engine 234 is configured to return a meeting location value associated with the highest density cluster. As such, in the provided example, the coordinates for Location B 325 (e.g., 47.639, −122.128) can be returned by the meeting location inference engine 234 based on the analysis conducted thereby.

In some embodiments, presentation component 230 generates user interface features associated with a determined probable meeting location value. Such features can include interface elements (such as graphics buttons, sliders, menus, audio prompts, alerts, alarms, vibrations, pop-up windows, notification-bar or status-bar items, in-app notifications, or other similar features for interfacing with a user), queries, and prompts. For example, presentation component 230 may present the user with a physical address associated with the probable meeting location value, a graphical display of the physical address (e.g., a GPS mapping), or may even present the user with all possible meeting location values or representations thereof ranked from highest probable meeting location value to lowest probable meeting location value.

As described previously, in some embodiments, a personalization-related service or application operating in conjunction with presentation component 230 determines when and how to present the probable meeting location value. In such embodiments, the output provided from meeting location inference engine 234 may be understood as a recommendation to the presentation component 230 (and/or personalization-related service or application) for when and how to present the probable meeting location value, which may be overridden by the personalization-related app or presentation component 230.

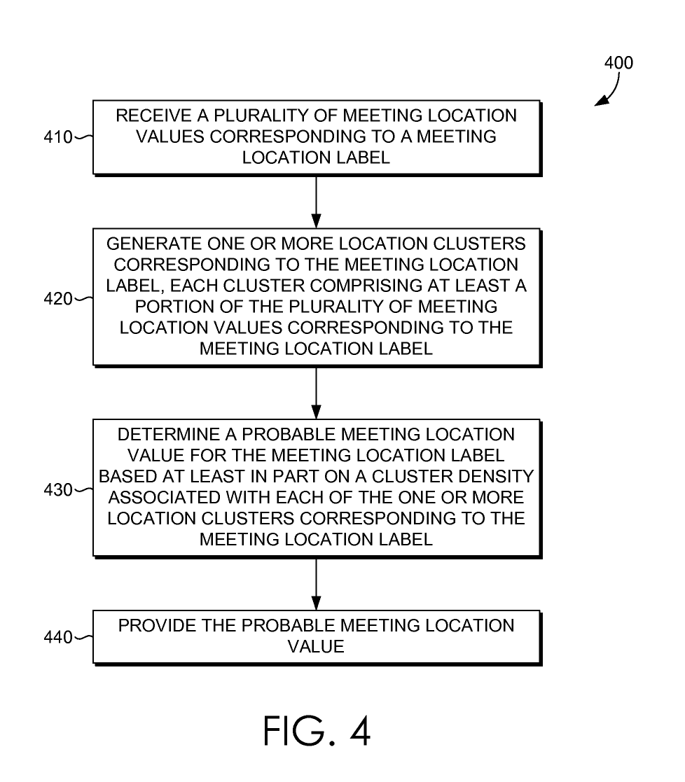

Turning now to FIG. 4, a flow diagram is provided illustrating one example method 400 for determining a probable meeting location value for a subjective meeting location label. Each block or step of method 400 and other methods described herein comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a stand-alone application, a service or hosted service (stand-alone or in combination with another hosted service), or a plug-in to another product, to name a few.

At step 410, a plurality of meeting location values corresponding to a meeting location label is received. As described herein, the meeting location label can be a subjective description of a meeting location that provides no context to the actual physical location of the calendared meeting. Embodiments of step 410 may occur over duration of time, wherein each of the meeting location values is collected over time, each also corresponding to one particular meeting location label (e.g., “Adi's Office). Each of the meeting location values can be determined based on user data that can be sensed by a plurality of sensors associated with a user.

In some embodiments, user data is monitored to generate a register about the user, which may comprise information about user activity, patterns, or interactions with meeting location values during at least calendared meeting times. From the meeting location register, meeting location values are identified based on features including user-visited locations or entities, recurring communications, online activity, etc., and may be inferred as relevant based on the level of association with the user, in one embodiment. In some embodiments, a meeting location value identified in the user data may be determined to be relevant based on user data (including interpretive data), and/or user profile information, which may include patterns of user-interactions with the meeting location value during calendared meeting times.

At step 420, one or more location clusters are generated, with each cluster corresponding to the meeting location label. Each cluster comprises at least a portion of the plurality of meeting location values corresponding to the meeting location label. In embodiments of step 420, the meeting location values in each of the one or more location clusters are associated with the meeting location label. Each cluster corresponds to a particular physical location, such as an address, GPS coordinates, or other physical location identifier.

At step 430, each of the one or more location clusters are analyzed to determine a cluster density associated therewith. The cluster density for each location cluster can be determined based on the number of meeting location values that are proximate to one another within the cluster. In some embodiments, a single cluster can be determined to have the highest cluster density by selecting the cluster comprising the highest number of meeting location values. In some embodiments, and as described hereinabove, a confidence score can be calculated for the single cluster having the highest cluster density. At step 440, a meeting location value or a representation thereof (e.g., an address, coordinates, a GPS map, etc.) associated with the single cluster having the highest cluster density is provided as an inference to a most probable meeting location value to be associated with the subjective meeting location label or description.

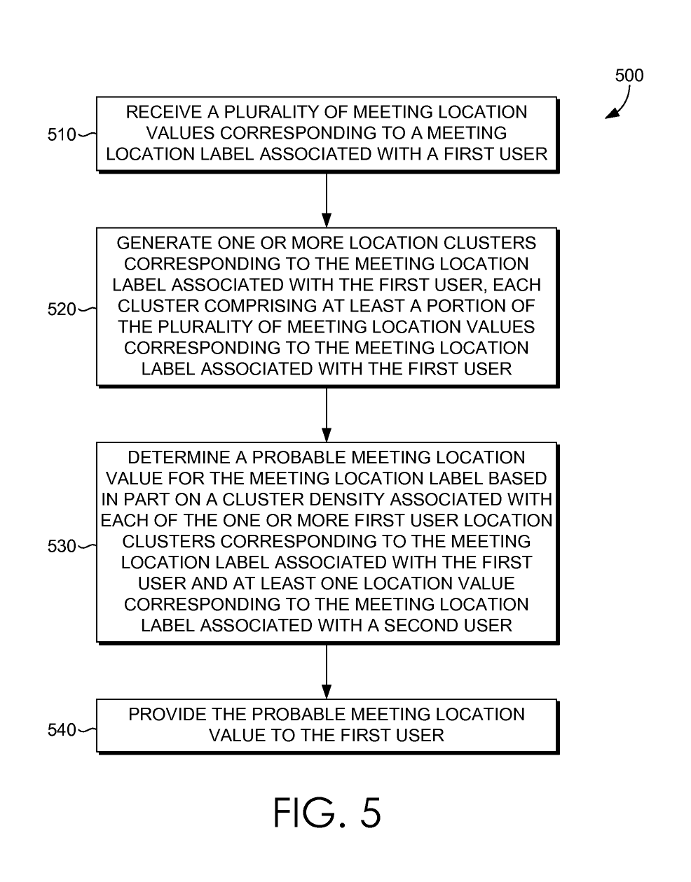

With reference now to FIG. 5, a flow diagram is provided illustrating one example method 500 for determining a probable meeting location value for a subjective meeting location label. At step 510, a plurality of meeting location values corresponding to a meeting location label is received. As described herein, the meeting location label can be a subjective description of a meeting location that provides no context to the actual physical location of the calendared meeting. Embodiments of step 510 may occur over duration of time, wherein each of the meeting location values is collected over time, each also corresponding to one particular meeting location label (e.g., “Adi's Office). Each of the meeting location values can be determined based on a first user's data that can be sensed by a plurality of sensors associated with the first user.

In some embodiments, the first user's data is monitored to generate a register about the first user, which may comprise information about user activity, patterns, or interactions with meeting location values during at least calendared meeting times. From the meeting location register, meeting location values are identified based on features including first user-visited locations or entities, recurring communications, online activity, etc., and may be inferred as relevant based on the level of association with the first user, in one embodiment. In some embodiments, a meeting location value identified in the first user data may be determined to be relevant based on first user data (including interpretive data), and/or first user profile information, which may include patterns of first user-interactions with the meeting location value during calendared meeting times.

At step 520, one or more location clusters are generated, with each cluster corresponding to the meeting location label. Each cluster comprises at least a portion of the plurality of meeting location values corresponding to the meeting location label. In embodiments of step 520, the meeting location values in each of the one or more location clusters are associated with the meeting location label. Each cluster corresponds to a particular physical location, such as an address, GPS coordinates, or other physical location identifier.

At step 530, each of the one or more location clusters are analyzed to determine a cluster density associated therewith. The cluster density for each location cluster can be determined based on the number of meeting location values that are proximate to one another within the cluster. In some embodiments, a single cluster can be determined to have the highest cluster density by selecting the cluster comprising the highest number of meeting location values. In some embodiments, and as described hereinabove, a confidence score can be calculated for the single cluster having the highest cluster density. In some other embodiments, user data for a second user can be analyzed to influence the confidence score. For instance, the second user and the first user may have correlating data, for instance, they may both share a common email domain name indicating that they are co-workers. In another instance, they may both be invitees to a common calendared meeting, and as such, user data from the second user's profile (for instance, user profile 260) may be incorporated into a confidence score calculation for the first user. In more detail, at least one location value that corresponds to the meeting location label being analyzed for the first user can be used to influence a confidence score for a particular meeting location value.

At step 540, a meeting location value or a representation thereof (e.g., an address, coordinates, a GPS map, etc.) associated with at least the single cluster having the highest cluster density and at least one location value corresponding to the meeting location label associated with the second user is provided as an inference to a most probable meeting location value to be associated with the subjective meeting location label or description.

Accordingly, we have described various aspects of technology directed to determining a probable meeting location value for a subjective meeting location label. It is understood that various features, sub-combinations, and modifications of the embodiments described herein are of utility and may be employed in other embodiments without reference to other features or sub-combinations. Moreover, the order and sequences of steps shown in the example methods 400 and 500 are not meant to limit the scope of the present invention in any way, and in fact, the steps may occur in a variety of different sequences within embodiments hereof. Such variations and combinations thereof are also contemplated to be within the scope of embodiments of the invention.

Having described various embodiments of the invention, an exemplary computing environment suitable for implementing embodiments of the invention is now described. With reference to FIG. 6, an exemplary computing device is provided and referred to generally as computing device 600. The computing device 600 is but one example of a suitable computing environment and is not intended to suggest any limitation as to the scope of use or functionality of the invention. Neither should the computing device 600 be interpreted as having any dependency or requirement relating to any one or combination of components illustrated.

Embodiments of the invention may be described in the general context of computer code or machine-useable instructions, including computer-useable or computer-executable instructions, such as program modules, being executed by a computer or other machine, such as a personal data assistant, a smartphone, a tablet PC, or other handheld device. Generally, program modules, including routines, programs, objects, components, data structures, and the like, refer to code that performs particular tasks or implements particular abstract data types. Embodiments of the invention may be practiced in a variety of system configurations, including handheld devices, consumer electronics, general-purpose computers, more specialty computing devices, etc. Embodiments of the invention may also be practiced in distributed computing environments where tasks are performed by remote-processing devices that are linked through a communications network. In a distributed computing environment, program modules may be located in both local and remote computer storage media including memory storage devices.

With reference to FIG. 6, computing device 600 includes a bus 610 that directly or indirectly couples the following devices: memory 612, one or more processors 614, one or more presentation components 616, one or more input/output (I/O) ports 618, one or more I/O components 620, and an illustrative power supply 622. Bus 610 represents what may be one or more busses (such as an address bus, data bus, or combination thereof). Although the various blocks of FIG. 6 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art and reiterate that the diagram of FIG. 6 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 6 and with reference to “computing device.”

Computing device 600 typically includes a variety of computer-readable media. Computer-readable media can be any available media that can be accessed by computing device 600 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by computing device 600. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Combinations of any of the above should also be included within the scope of computer-readable media.

Memory 612 includes computer storage media in the form of volatile and/or nonvolatile memory. The memory may be removable, non-removable, or a combination thereof. Exemplary hardware devices include solid-state memory, hard drives, optical-disc drives, etc. Computing device 600 includes one or more processors 614 that read data from various entities such as memory 612 or I/O components 620. Presentation component(s) 616 presents data indications to a user or other device. Exemplary presentation components include a display device, speaker, printing component, vibrating component, and the like.

The I/O ports 618 allow computing device 600 to be logically coupled to other devices, including I/O components 620, some of which may be built in. Illustrative components include a microphone, joystick, game pad, satellite dish, scanner, printer, wireless device, etc. The I/O components 620 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on the computing device 600. The computing device 600 may be equipped with depth cameras, such as stereoscopic camera systems, infrared camera systems, RGB camera systems, and combinations of these, for gesture detection and recognition. Additionally, the computing device 600 may be equipped with accelerometers or gyroscopes that enable detection of motion. The output of the accelerometers or gyroscopes may be provided to the display of the computing device 600 to render immersive augmented reality or virtual reality.

Some embodiments of computing device 600 may include one or more radio(s) 624 (or similar wireless communication components). The radio 624 transmits and receives radio or wireless communications. The computing device 600 may be a wireless terminal adapted to receive communications and media over various wireless networks. Computing device 600 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include, by way of example and not limitation, a Wi-Fi® connection to a device (e.g., mobile hotspot) that provides access to a wireless communications network, such as a WLAN connection using the 802.11 protocol; a Bluetooth connection to another computing device is a second example of a short-range connection, or a near-field communication connection. A long-range connection may include a connection using, by way of example and not limitation, one or more of CDMA, GPRS, GSM, TDMA, and 802.16 protocols.

Many different arrangements of the various components depicted, as well as components not shown, are possible without departing from the scope of the claims below. Embodiments of the present invention have been described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

What is claimed is:

1. A computerized system comprising:
one or more sensors configured to provide sensor data;
a calendar interfacing component configured to receive a meeting location label corresponding to one or more calendar meetings associated with a user;
a meeting location register configured to record one or more meeting location values corresponding to the meeting location label and based at least in part on the sensor data;
a meeting location analyzer configured to analyze at least parts of the one or more meeting location values recorded in the meeting location register;
one or more processors; and
one or more computer storage media storing computer-useable instructions that, when used by the one or more processors, cause the one or more processors to perform operations comprising:
determining, using the meeting location analyzer, a probable meeting location value for the meeting location label based at least in part on the one or more meeting location values recorded in the meeting location register; and
providing the probable meeting location value or a representation thereof to the user.

2. The system of claim 1, wherein the meeting location analyzer is configured to analyze the one or more meeting location values recorded in the meeting location register by generating one or more location clusters based on the one or more meeting location values recorded in the meeting location register, each location cluster comprising at least a portion of the one or more meeting location values recorded in the meeting location register.

3. The system of claim 2, wherein determining the probable meeting location value comprises:
analyzing each of the one or more location clusters to calculate a cluster density associated therewith; and
determining the probable meeting location value based at least in part on the cluster density associated with each of the one or more location clusters.

4. The system of claim 3, wherein determining the probable meeting location value is further based in part on a density value associated with a highest density location cluster selected from the one or more location clusters and compared to a predetermined confidence threshold.

5. The system of claim 1, wherein the meeting location label comprises at least one of a room number, a location name, and a meeting subject.

6. The system of claim 1, wherein the meeting location values and the probable meeting location value each comprise a latitudinal coordinate and a longitudinal coordinate.

7. The system of claim 1, the one or more calendar meetings each having a meeting time associated therewith, and wherein the meeting location register is configured to record, for the one or more meeting location values corresponding to the meeting location label, the sensor data provided during the meeting time.

8. The system of claim 1, wherein the sensor data is associated with one or more users.

9. The system of claim 1, wherein the sensor data comprises location information.

10. A computerized method for providing a probable meeting location value or a representation thereof to a user, the method comprising:
receiving a plurality of meeting location values corresponding to a meeting location label associated with the user, each of the meeting location values based at least in part on sensor data associated with the user;
generating one or more location clusters corresponding to the meeting location label associated with the user, each cluster comprising at least a portion of the plurality of meeting location values corresponding to the meeting location label associated with the user;
determining a probable meeting location value for the meeting location label associated with the user, the probable meeting location value being determined based at least in part on a cluster density associated with each of the one or more location clusters corresponding to the meeting location label associated with the user;
providing the probable meeting location value or a representation thereof to the user.

11. The method of claim 10, wherein the probable meeting location value is further determined based on a confidence score corresponding to the cluster density associated with each of the one or more location clusters.

12. The method of claim 10, wherein the probable meeting location value is further determined based on at least one location value corresponding to the meeting location value associated with a second user, wherein the user and second user share correlating data.

13. The method of claim 12, wherein the correlating data includes at least one of a common email domain name, a common calendar meeting associated with the meeting location label, and a common history of meeting location values.

14. The method of claim 10, wherein the meeting location label is associated with the user when the user is an invitee to a calendar meeting associated with the meeting location label.

15. The method of claim 10, further comprising receiving a request for the probable meeting location value based on the meeting location label associated with the user.

16. A non-transitory computer storage medium storing computer-useable instructions that, when used by one or more computing devices, cause the one or more computing devices to perform operations comprising:
receiving a plurality of meeting location values corresponding to a meeting location label associated with a first user, each of the meeting location values based at least in part on sensor data associated with the first user;
generating one or more first user location clusters corresponding to the meeting location label associated with the first user, each first user location cluster comprising at least a portion of the plurality of meeting location values corresponding to the meeting location label associated with the first user;
determining a probable meeting location value for the meeting location label associated with the first user, the probable meeting location value being determined based at least in part on:
a cluster density associated with each of the one or more first user location clusters corresponding to the meeting location label associated with the first user, and
at least one location value corresponding to the meeting location label associated with a second user,
wherein the first user and the second user share correlating data;
providing the probable meeting location value or a representation thereof to the first user.

17. The medium of claim 16, wherein the first user and the second user share correlating data by each having at least one of a common email domain name, a common calendar meeting associated with the meeting location label, or a common history of meeting location values.

18. The medium of claim 16, wherein the probable meeting location value is further determined based on a density value associated with a highest density first user location cluster selected from the one or more first user location clusters and compared to a predetermined confidence threshold.

19. The medium of claim 16, wherein the meeting location label comprises at least one of a room number, a location name, and a meeting subject.

20. The medium of claim 16, wherein the meeting location values and the probable meeting location value each comprise a latitudinal coordinate and a longitudinal coordinate.
